(19) United States
(12) Patent Application Publication
(10) Pub. No.: US 2004/0211192 A1
(43) Pub. Date: Oct. 28, 2004

(54) Method for the disposal of boil-off gas from a cryotank, and a motor vehicle having a cryotank

(75) Inventor: Werner Lechner, Taufkirchen (DE)

Correspondence Address: CROWELL & MORING LLP, INTELLECTUAL PROPERTY GROUP, P.O. BOX 14300, WASHINGTON, DC, 20044-4300, US

(73) Assignee: BAYERISCHE MOTOREN WERKE AG, Muenchen (DE)

(21) Appl. No.: 10/849,208

(22) Filed: May 20, 2004

Related U.S. Application Data
(63) Continuation of application No. PCT/EP02/13653, filed on Dec. 3, 2002.

(30) Foreign Application Priority Data
Jan. 22, 2002 (DE) 102 02 172.4

(51) Int. Cl. F17C 13/02; F17C 13/08

(52) U.S. Cl. 62/53.2; 62/49.1

(57) ABSTRACT

In a method for the disposal of the boil-off gas in a cryotank, an energy-converting unit is temporarily operated even in phases of non-use in order to burn the boil-off gas. Preferably the start-up and/or the duration of the operation of the energy-converting unit is controlled by an electronic monitor module according to the pressure level in the cryotank. A preferred case of operation is represented by a motor vehicle with a cryotank for supplying a vehicle driving unit or a fuel cell for the generation of electrical energy, wherein the drive unit or the fuel cell of the shut-down, unused motor vehicle is automatically started up temporarily automatically in order to burn boil-off gas.

This application is a continuation of international patent application no. PCT/EP02/13653, filed Dec. 3, 2002, designating the United States of America, and published in German as WO 03/062698 A1, the entire disclosure of which is incorporated herein by reference. Priority is claimed based on German patent application no. 102 02 172.4, filed Jan. 22, 2002.

The invention relates to a method for the disposal of boil-off gas in a cryotank from the fuel situated therein to supply an energy-converting unit. The invention furthermore relates to a motor vehicle with a cryotank for supplying a vehicle propelling unit or energy converter, e.g., a fuel cell for the production of electrical energy, as well as with an apparatus for burning boil-off gas from the cryotank.

Fuels of great interest for the future, for the propulsion of motor vehicles, such as hydrogen or natural gas, for example, or the like, can only be liquefied in a relatively favorable manner and thus they can be stored only at very low temperatures. In this kind of cryogenic fuel storage, however, a small amount of liquid fuel evaporates due to heat entering the fuel tank, forming what is known as boil-off gas. Especially when no machinery for consuming the fuel is running, i.e., especially when the internal combustion engine or fuel cell or the like driving the motor vehicle (i.e., generally an energy converter, e.g., for producing electrical energy) is not in operation, the tank's internal pressure increases as a result. For reasons of safety this pressure must be limited by opening valves. In general, the boil-off gas is then released into the environment through blow-off lines in which the said valves are provided.

A method is disclosed in EP 0 745 499 B1 involving the temporary storage of the boil-off gases and catalytic oxidation of liquid natural gas as cryogenic fuel. Moreover, EP 0 069 717 B1 describes the employment of the boil-off gas as propellant fuel for a dual-fuel internal combustion engine of a ship, namely one that can operate on either heavy oil or gas.

Basically, the combustion of the boil-off gas, including its catalytic oxidation, is more desirable than the mere blowing off of the (combustible) boil-off gas into the environment. If the boil-off gases are burned, e.g., in a catalyst of an independent burner, (local) reaction heat is necessarily formed. This must be taken into account in the arrangement of a so-called combustion apparatus, such as for example a catalyzer or an independent burner with a homogeneous flame, because under certain circumstances this reaction heat can overheat adjacent components in the vehicle, unless it is assured that this reaction heat is controlled. An obvious (additional) disadvantage of an independent apparatus for the combustion of boil-off gas is the high cost of construction, because ultimately this combustion apparatus must be contained in the usually limited space available in a motor vehicle. This is especially true also of an intermediate storage device proposed in the known state of the art.

An object of the present invention is to solve or alleviate the above problem.

In one aspect of the invention, the drive unit or energy converter of the parked, unused motor vehicle is started up automatically in order to burn boil-off gas.

Beyond the special application described thus far, namely that the cryotank is provided in a motor vehicle in order to store propellant or fuel for the motor vehicle's engine or to store a fuel cell or the like on board the vehicle, the proposal of the invention can generally be applied also to the utilization of boil-off gas from a cryotank.

In this respect, an especially advantageous method is also to be described (an additional problem of the present invention), wherein this boil-off gas forms from the fuel that is stored in the cryotank to supply a generally energy-consuming unit. This generally energy-consuming unit can be a burner to produce thermal energy, or an engine for producing mechanical energy, or a chemical apparatus for the production of electrical energy, and many more.

To solve this additional problem it is proposed that the energy-converting unit be started up from time to time in non-use phases in order to burn the boil-off gas. The term, “non-use phase” is to be understood as a fairly long time interval during which the unit is basically not needed and therefore should actually not be in operation. However, since (depending on the duration of this phase and on other marginal conditions) a considerable amount of boil-off gas can collect in the cryotank—finally no fuel is needed from the cryotank to supply the unit—now, according to the invention, the energy-consuming unit is necessarily to be started up for at least until a sufficient amount of the developed boil-off gas has been burned in it. That is to say, although the unit actually would not have to run, nevertheless it is operated temporarily in order to burn the boil-off gas and thus dispose of it.

Getting back to the special case wherein a motor vehicle with a cryotank which is used to supply a vehicle propelling unit or an energy converter, e.g., a piston-type internal combustion engine or a fuel cell as a device for burning the boil-off gas. Since at least one of these elements is present anyway, and each of these elements is of course suitable for the purpose of burning gaseous fuel from the cryotank (and thus also the boil-off gas), the expense of the implementation of this proposal is minimal.

In that case the start-up and/or the duration of the operation of the propelling unit can be controlled by an electronic monitor according to the pressure level in the cryotank. It is thus proposed, preferably upon reaching a certain pressure in the tank, to engage the fuel supplying system of the vehicle and start the internal combustion engine or the fuel cell or the like automatically, i.e., without any action by the driver or operator. This boil-off gas-fueled device then remains in operation until the pressure build-up in the cryotank has reached a certain value. Thereafter this device, i.e., the internal combustion engine or the fuel cell or the like, is then automatically stopped again. The automatic starting and stopping is controlled preferably by an electronic monitor which can be integrated into the on-board computer of the motor vehicle in the form of software.

Comparable considerations apply to the general arrangement of the present invention, namely in regard to the general procedure proposed as well as its further development, according to which the start-up and/or the duration of the operation of the energy-consuming unit is controlled in relation to the pressure level in the cryotank by an electronic monitor. The advantages explained are likewise true for the general variants of the idea of the invention, as well as for the special embodiment on a motor vehicle, which will be dealt with hereinafter in greater detail.

Thus, the motor vehicle propulsion unit, or an energy converter provided in the vehicle especially for its propulsion (e.g., the previously mentioned fuel cell for generating electric power), is employed to make use of the boil-off gases of the cryotank system. At least one of these said systems is contained in the vehicle anyway. Thus no space and no weight of additional components has to be provided in the vehicle. Also, no hardware-specific manufacture and life-cycle costs are incurred. The proposed boil-off system almost automatically has the life and reliability of the motor unit or fuel cell or the like.

Advantageously, all of the energy consuming devices that may be present in a motor vehicle are directly or indirectly connected with the internal combustion energy and the fuel cell. They can be started up and maintained without additional devices. Advantageously, the energy thus liberated can also be reused, e.g., for charging a storage battery, for air-conditioning when the vehicle is standing, or for supplying the electrical system, and more. An independent boil-off system, on the other hand, would have to be incorporated at great expense into the corresponding energy circuits.

Advantageously, the internal combustion engine and the fuel cell each represent a large thermal mass and can therefore absorb the heat formed in the boil-off operation over a long period of time, and slowly release it again. Any heat damage to adjacent components is therefore impossible.

Even in case of a cryotank insulation failure in which more (i.e., a greater volume of) boil-off gas or gases develops, as is commonly anticipated, the internal combustion engine and the fuel cell are equipped to deal with it. The great range of power modulation, by increasing the rotatory speed of the internal combustion engine, for example, permits the problem-free recovery of large amounts of fuel. Also, blowing apparatus can be started up in order to flush out areas of the fuel supply system or also the interior of the vehicle and thus eliminate possible leakage, and it is also to be pointed out that a great number of details can be made different from the above explanations without departing from the content of the claims.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A method for the disposal of the boil-off gas forming in a cryotank from the fuel contained therein for the supply of an energy-converting unit, the energy-converting unit is started up temporarily even in phases of non-use, in order to burn the boil-off gas.

2. The method according to claim 1, wherein the start-up and/or the length of time of the operation of the energy-converting unit is controlled according to the pressure level in the cryotank by an electronic monitor module.

3. A motor vehicle with a cryotank for supplying a vehicle propulsion unit or an energy converter, e.g., a fuel cell for generating electric energy, and having an apparatus for the combustion of boil-off gas from the cryotank, characterized in that the driving unit or the energy converter of the shut-down, unused motor vehicle, is automatically started up in order to burn boil-off gas.

4. The motor vehicle according to claim 3, wherein the starting up and/or the term of operation of the propulsion unit or of the energy converter is controlled according to the pressure level in the cryotank by an electronic monitor module.

5. A method for disposing boil-off gas forming in a cryotank of a vehicle, the method comprising the step of periodically operating an energy-converting unit, which generates energy for the propulsion of the vehicle, to consume the boil-off gas when the vehicle is not in use.

6. The method according to claim 5, further comprising controlling the length of the energy-converting unit operation as a function of the pressure level in the cryotank.

7. The method according to claim 5, further comprising supplying the energy generated by burning the boil-off gas to an energy consuming device.

8. The method according to claim 7, wherein the energy consuming device is an air conditioning unit.

9. The method according to claim 5, further comprising supplying the energy generated by burning the boil-off gas to an energy storage device.

10. The method according to claim 7, wherein the energy storage device is a battery.

11. A motor vehicle comprising:
an energy-converting unit that generates energy for the propulsion of the vehicle;
a cryotank for storing fuel and supplying the fuel to the energy-converting unit; and
a controller that is configured to periodically operate the energy-converting unit to consume boil-off gas of the cryotank when the vehicle is not in use.

12. The motor vehicle according to claim 11, wherein the controller controls the length of the energy-converting unit operation as a function of the pressure level in the cryotank.

13. The motor vehicle according to claim 11, wherein the energy generated by burning the boil-off gas is supplied to an energy consuming device.

14. The motor vehicle according to claim 13, wherein the energy consuming device is an air conditioning unit.

15. The motor vehicle according to claim 11, wherein the energy generated by burning the boil-off gas is supplied to an energy storage device.

16. The motor vehicle according to claim 15, wherein the energy storage device is a battery.
